(19) United States
(12) Patent Application Publication
(10) Pub. No.: US 2024/0230837 A9
(43) Pub. Date: Jul. 11, 2024

(54) RADIO WAVE SENSOR INSTALLATION METHOD AND SIGHTING DEVICE

(71) Applicant: Sumitomo Electric Industries, Ltd., Osaka-shi, Osaka (JP)

(72) Inventors: Hiroaki KAWANISHI, Osaka-shi, Osaka (JP); Yasuo OGIUCHI, Osaka-shi, Osaka (JP)

(73) Assignee: Sumitomo Electric Industries, Ltd., Osaka-shi, Osaka (JP)

(21) Appl. No.: 18/277,775

(22) PCT Filed: Dec. 20, 2021
(86) PCT No.: PCT/JP2021/046983

§ 371 Date: Aug. 18, 2023

(30) Foreign Application Priority Data
Mar. 5, 2021 (JP) 2021-035000

(51) Int. Cl. G01S 7/40

(52) U.S. Cl. CPC G01S 7/4034; G01S 13/91

(57) ABSTRACT

A radio wave sensor installation method has the following steps. A sighting device is mounted onto a radio wave sensor. The direction of the radio wave sensor is adjusted using the sighting device. The direction of the radio wave sensor is fixed. The sighting device is removed from the radio wave sensor. The sighting device includes a first transparent member and a second transparent member different from the first transparent member. In the step of adjusting the direction of the radio wave sensor using the sighting device, the direction of the radio wave sensor is adjusted using a first sighting mark indicated on the first transparent member and a second sighting mark indicated on the second transparent member.

### TECHNICAL FIELD

The present disclosure relates to a radio wave sensor installation method and a sighting device. The present application claims priority based on Japanese Patent Application No. 2021-035000 that is a Japanese patent application filed on Mar. 5, 2021. All contents of the description given in this Japanese patent application are incorporated in this specification by reference.

### BACKGROUND ART

Japanese Patent Laying-Open No. 2019-132643 (Patent Literature 1) describes a method of adjusting the direction of a radio wave sensor using a sighting device. This radio wave sensor is mainly directed toward a target area including a crosswalk.

### CITATION LIST

### Patent Literature

PTL 1: Japanese Patent Laying-Open No. 2019-132643

### SUMMARY OF INVENTION

A radio wave sensor installation method according to the present disclosure includes the following steps. A sighting device is mounted onto a radio wave sensor. The direction of the radio wave sensor is adjusted using the sighting device. The direction of the radio wave sensor is fixed. The sighting device is removed from the radio wave sensor. The sighting device includes a first transparent member and a second transparent member different from the first transparent member. In the step of adjusting the direction of the radio wave sensor using the sighting device, the direction of the radio wave sensor is adjusted using a first sighting mark indicated on the first transparent member and a second sighting mark indicated on the second transparent member.

A sighting device according to the present disclosure includes a first transparent member and a second transparent member. The second transparent member is different from the first transparent member. The first transparent member is provided with a first sighting mark. The second transparent member is provided with a second sighting mark. The first sighting mark has a shape that encompasses the second sighting mark when seen in a direction from the first transparent member toward the second transparent member in a state where the first transparent member and the second transparent member are overlapped.

A sighting device according to the present disclosure includes a first transparent member and a second transparent member. The second transparent member is different from the first transparent member. The first transparent member is provided with a first sighting mark. The second transparent member is provided with a second sighting mark. The first sighting mark is a first graph-paper pattern, and the second sighting mark is a second graph-paper pattern.

A sighting device according to the present disclosure includes a first transparent member and a second transparent member. The second transparent member is different from the first transparent member. The first transparent member is provided with a first sighting mark. The second transparent member is provided with a second sighting mark. The first sighting mark is a first concentric-circle pattern, and the second sighting mark is a second concentric-circle pattern.

### BRIEF DESCRIPTION OF DRAWINGS

FIG. 1 is a schematic view showing a direction of a radio wave sensor and a direction of a sighting device.

FIG. 2 is a flowchart schematically showing a radio wave sensor installation method according to a first embodiment.

FIG. 3 is a schematic perspective view showing the configuration of the radio wave sensor.

FIG. 4 is a schematic perspective view showing the configuration of the sighting device according to the first example.

FIG. 5 is a schematic view showing a state where a first transparent member and a second transparent member are overlapped.

FIG. 6 is a schematic side view showing a step of mounting the sighting device onto the radio wave sensor.

FIG. 7 is a schematic side view showing a step of adjusting the direction of the radio wave sensor using the sighting device.

FIG. 8 is a schematic view showing a state where a region constituting a detection target is observed through the first transparent member and the second transparent member.

FIG. 9 is a schematic side view showing a step of removing the sighting device from the radio wave sensor.

FIG. 10 is a schematic perspective view showing the configuration of a sighting device according to a second example.

FIG. 11 is a schematic perspective view showing the configuration of a sighting device according to a third example.

FIG. 12 is a schematic perspective view showing the configuration of a sighting device according to a fourth example.

FIG. 13 is a schematic perspective view showing a first modified example of the step of mounting the sighting device onto the radio wave sensor.

FIG. 14 is a schematic perspective view showing a second modified example of the step of mounting the sighting device onto the radio wave sensor.

FIG. 15 is a schematic perspective view showing a third modified example of the step of mounting the sighting device onto the radio wave sensor.

FIG. 16 is a schematic perspective view showing a fourth modified example of the step of mounting the sighting device onto the radio wave sensor.

FIG. 17 is a schematic perspective view showing a fifth modified example of the step of mounting the sighting device onto the radio wave sensor.

FIG. 18 is a schematic perspective view showing a sixth modified example of the step of mounting the sighting device onto the radio wave sensor.

FIG. 19 is a schematic perspective view showing a seventh modified example of the step of mounting the sighting device onto the radio wave sensor.

FIG. 20 is a schematic perspective view showing the configuration of a sighting device according to a fifth example.

### DETAILED DESCRIPTION

### Problem to be Solved by the Present Disclosure

Generally, a traveling speed of a vehicle is faster than a walking speed of a pedestrian. Accordingly, a distance that a vehicle travels is longer than a distance that a pedestrian walks in the same time. Therefore, a radio wave sensor used to detect vehicles is required to detect a region of a larger area than a radio wave sensor used to detect pedestrians.

The sighting device described in Patent Literature 1 has a plurality of plate-like members. Each of the plurality of plate-like members is provided with a hole. A worker who adjusts the direction of a radio wave sensor looks through a hole provided in a plate-like member close to the worker's eyes into a hole provided in another plate-like member. The worker adjusts the direction of the radio wave sensor while checking the surroundings of a reference point located near a crosswalk through these two holes.

However, the region that is visually recognizable through these two holes is a very limited small area. Therefore, when adjusting the direction of a radio wave sensor required to detect a region of a large area, it has been difficult to quickly grasp the conditions around the reference point.

The present disclosure has been contrived to solve the challenge as described above, and aims to provide a radio wave sensor installation method and a sighting device that allow the conditions around a reference point to be quickly grasped.

### Advantageous Effects of the Present Disclosure

According to the present disclosure, a radio wave sensor installation method and a sighting device that allow the conditions around a reference point to be quickly grasped can be provided.

### DESCRIPTION OF EMBODIMENTS

First, an overview of embodiments of the present disclosure will be described.

(1) An installation method of a radio wave sensor 100 according to the present disclosure includes the following steps. A sighting device 30 is mounted onto radio wave sensor 100. The direction of radio wave sensor 100 is adjusted using sighting device 30. The direction of radio wave sensor 100 is fixed. Sighting device 30 is removed from radio wave sensor 100. Sighting device 30 includes a first transparent member 10 and a second transparent member 20 different from first transparent member 10. In the step of adjusting the direction of radio wave sensor 100 using sighting device 30, the direction of radio wave sensor 100 is adjusted using a first sighting mark 1 indicated on first transparent member 10 and a second sighting mark 2 indicated on second transparent member 20.

According to the installation method of radio wave sensor 100 as described in (1) above, sighting device 30 includes first transparent member 10 and second transparent member 20. The direction of radio wave sensor 100 is adjusted using first sighting mark 1 indicated on first transparent member 10 and second sighting mark 2 indicated on second transparent member 20. Thus, a worker can visually recognize a large region around the reference point through each of first transparent member 10 and second transparent member 20. Therefore, compared with when sighting device 30 is a non-transparent member, the conditions around the reference point can be quickly grasped.

(2) According to the installation method of radio wave sensor 100 as described in (1) above, in the step of adjusting the direction of radio wave sensor 100 using sighting device 30, the direction of radio wave sensor 100 may be adjusted such that a first sighting point on first sighting mark 1, a second sighting point on second sighting mark 2, and a reference point located on the ground are aligned in a straight line. Thus, the accuracy of adjusting the direction of radio wave sensor 100 can be improved.

(3) According to the installation method of radio wave sensor 100 as described in (2) above, first sighting mark 1 may be a first graph-paper pattern, and second sighting mark 2 may be a second graph-paper pattern. A first grid point of the first graph-paper pattern may be a first sighting point 81, and a second grid point of the second graph-paper pattern may be a second sighting point 82. Thus, the flexibility in selecting each of first sighting point 81 and second sighting point 82 increases. Therefore, an appropriate position of the reference point can be selected according to the actual road shape.

(4) According to the installation method of radio wave sensor 100 as described in (3) above, the method may further include, before the step of adjusting the direction of radio wave sensor 100 using sighting device 30, a step of drawing a mark at each of the first grid point and the second grid point.

(5) According to the installation method of radio wave sensor 100 as described in (1) above, in the step of adjusting the direction of radio wave sensor 100 using sighting device 30, the direction of radio wave sensor 100 may be adjusted such that the shape of first sighting mark 1 overlaps the shape of second sighting mark 2 as seen from a position located on the opposite side of first transparent member 10 from second transparent member 20 in a state where first transparent member 10 and second transparent member 20 are disposed facing each other. Thus, the accuracy of adjusting the direction of radio wave sensor 100 can be improved.

(6) According to the installation method of radio wave sensor 100 as described in (1) above, the method may further include, before the step of mounting sighting device 30 onto radio wave sensor 100, a step of selecting first transparent member 10 having a shape conforming to the shape of a road constituting a detection target.

(7) According to the installation method of radio wave sensor 100 as described in (1) above, in the step of adjusting the direction of radio wave sensor 100 using sighting device 30, first sighting mark 1 may be projected onto first transparent member 10.

(8) According to the installation method of radio wave sensor 100 as described in (1) above, the method may further include, before the step of adjusting the direction of radio wave sensor 100 using sighting device 30, a step of drawing first sighting mark 1 on first transparent member 10.

(9) According to the installation method of radio wave sensor 100 as described in any one of (1) to (8) above, a straight line connecting first sighting mark 1 and second sighting mark 2 and a straight line along the direction of radio wave sensor 100 may be skew.

(10) According to the installation method of radio wave sensor 100 as described in any one of (1) to (9) above, radio wave sensor 100 may be provided with a first positioning mark 60. First transparent member 10 may be provided with a second positioning mark 70. In the step of mounting sighting device 30 onto radio wave sensor 100, first positioning mark 60 may be aligned with second positioning mark 70. Thus, the accuracy of positioning sighting device 30 relative to radio wave sensor 100 can be improved. As a result, the accuracy of adjusting the direction of radio wave sensor 100 can be improved.

(11) According to the installation method of radio wave sensor 100 as described in any one of (1) to (9) above, radio wave sensor 100 may be provided with a recess 63. In the step of mounting sighting device 30 onto radio wave sensor 100, first transparent member 10 may be fitted into recess 63. Thus, the accuracy of positioning sighting device 30 relative to radio wave sensor 100 can be improved. As a result, the accuracy of adjusting the direction of radio wave sensor 100 can be improved.

(12) According to the installation method of radio wave sensor 100 as described in any one of (1) to (9) above, radio wave sensor 100 may be provided with a projecting part 80. First transparent member 10 may be provided with a hole 90. In the step of mounting sighting device 30 onto radio wave sensor 100, projecting part 80 may be inserted into hole 90. Thus, the accuracy of positioning sighting device 30 relative to radio wave sensor 100 can be improved. As a result, the accuracy of adjusting the direction of radio wave sensor 100 can be improved.

(13) Sighting device 30 according to the present disclosure includes first transparent member 10 and second transparent member 20. Second transparent member 20 is different from first transparent member 10. First transparent member 10 is provided with first sighting mark 1. Second transparent member 20 is provided with second sighting mark 2. Second sighting mark 2 has a shape that encompasses first sighting mark 1 when seen in a direction from first transparent member 10 toward second transparent member 20 in a state where first transparent member 10 and second transparent member 20 are overlapped.

Sighting device 30 as described in (13) above includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped.

(14) Sighting device 30 according to the present disclosure includes first transparent member 10 and second transparent member 20. Second transparent member 20 is different from first transparent member 10. First transparent member 10 is provided with first sighting mark 1. Second transparent member 20 is provided with second sighting mark 2. First sighting mark 1 is a first graph-paper pattern, and second sighting mark 2 is a second graph-paper pattern.

Sighting device 30 as described in (14) above includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped. First sighting mark 1 is the first graph-paper pattern, and second sighting mark 2 is the second graph-paper pattern. Thus, the flexibility in selecting each of first sighting point 81 of first sighting mark 1 and second sighting point 82 of second sighting mark 2 increases. Therefore, an appropriate position of the reference point can be selected according to the actual road shape.

(15) Sighting device 30 according to the present disclosure includes first transparent member 10 and second transparent member 20. Second transparent member 20 is different from first transparent member 10. First transparent member 10 is provided with first sighting mark 1. Second transparent member 20 is provided with second sighting mark 2. First sighting mark 1 is a first concentric-circle pattern, and second sighting mark 2 is a second concentric-circle pattern.

Sighting device 30 as described in (15) above includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped. First sighting mark 1 is the first concentric-circle pattern, and second sighting mark 2 is the second concentric-circle pattern. The concentric-circle patterns reflect the radiation characteristics of radio waves. Therefore, the worker can easily imagine the radiation characteristics of radio waves. For example, the worker can adjust the direction of radio wave sensor 100 while checking whether the detection target region is located within the radiation range of radio waves.

### Details of Embodiments of the Present Disclosure

Details of embodiments of the present disclosure will be described below. In the following description, the same or corresponding elements will be denoted by the same reference signs, and the same description thereof will not be repeated.

### First Embodiment

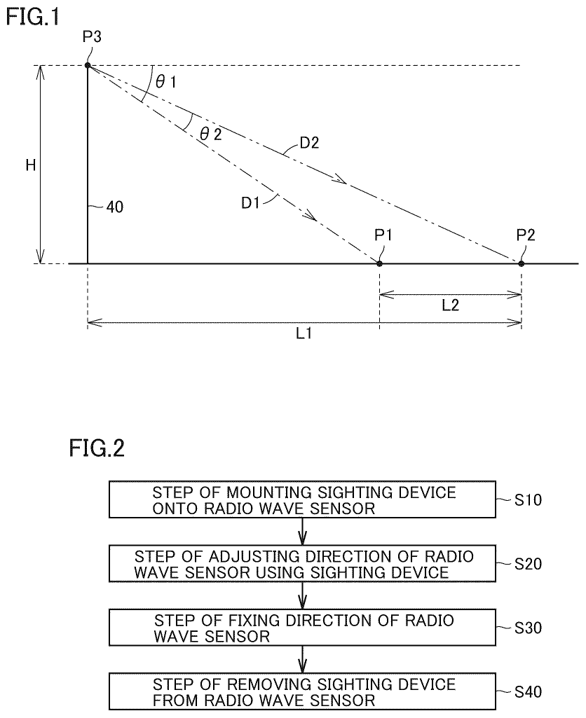

First, an installation method of radio wave sensor 100 according to a first embodiment of the present disclosure will be described. FIG. 1 is a schematic view showing a direction of the radio wave sensor and a direction of the sighting device. Radio wave sensor 100 according to the first embodiment is used, for example, to detect vehicles. In FIG. 1, radio wave sensor 100 is installed, for example, at a mounting position P3 of a support member 40.

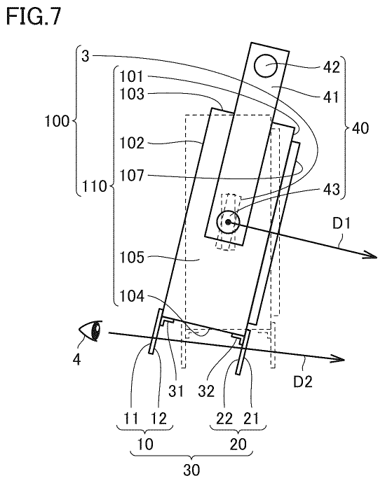

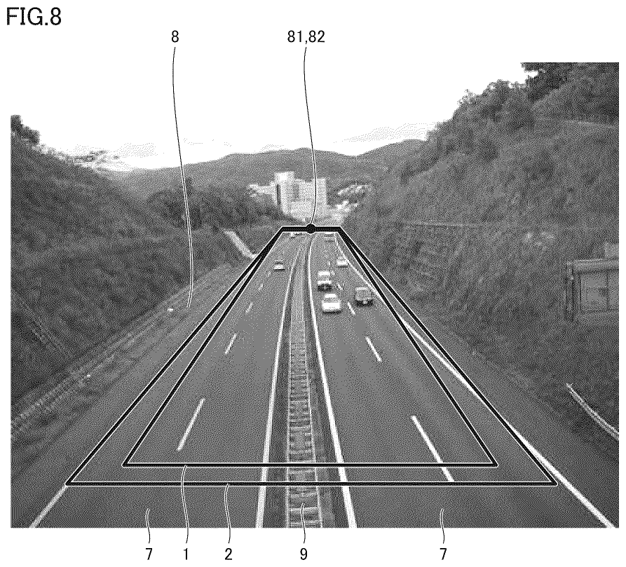

A first direction D1 is the direction of radio wave sensor 100. Specifically, first direction D1 is an emission direction of radio waves emitted from radio wave sensor 100. A second direction D2 is the direction of sighting device 30. The direction of sighting device 30 is a direction of taking sight (in other words, a sighting direction), and is more particularly a direction from first sighting point 81 on first sighting mark 1 toward second sighting point 82 on second sighting mark 2 (see FIG. 7 and FIG. 8). Generally, second direction D2 is different from first direction D1. Radio waves emitted from radio wave sensor 100 cover a detection target region. The detection target region is, for example, a region including a roadway. A first point P1 is, for example, the center of a region to which radio waves are emitted. First point P1 is included in the detection target region. A second point P2 is, for example, a reference point located on the ground. Specifically, the reference point is disposed on a road, a median strip, a road shoulder, etc. For example, the reference point may be a part that is supported on a support rod extending from the ground surface like a road sign. From another perspective, the reference point itself need not be in contact with the ground surface as long as the reference point is in contact with the ground surface through a member supporting it. While the distance between first point P1 and second point P2 (a second distance L2) is not particularly limited, it is, for example, 100 m.

An angle of depression of radio wave sensor 100 (a first angle θ1) is adjusted such that, for example, radio waves emitted from radio wave sensor 100 cover the entire detection target region. An angle formed by first direction D1 and second direction D2 (a second angle θ2) is set based on an installation height H of radio wave sensor 100 and the distance from radio wave sensor 100 to the reference point (first distance L1). Specifically, second angle θ2 is set so as to meet an expression: θ2=θ1−arctan (H/L1). A worker adjusts radio wave sensor 100 to an appropriate direction by aligning the direction of sighting device 30 with second point P2 in a state where radio wave sensor 100 is mounted on support member 40.

FIG. 2 is a flowchart schematically showing the installation method of radio wave sensor 100 according to the first embodiment. As shown in FIG. 2, the installation method of radio wave sensor 100 according to the first embodiment mainly has a step of mounting the sighting device onto the radio wave sensor (S10), a step of adjusting the direction of the radio wave sensor using the sighting device (S20), a step of fixing the direction of the radio wave sensor (S30), and a step of removing the sighting device from the radio wave sensor (S40).

First, the step of mounting sighting device 30 onto radio wave sensor 100 (S10) is performed. In the step of mounting sighting device 30 onto radio wave sensor 100 (S10), radio wave sensor 100 and sighting device 30 are prepared.

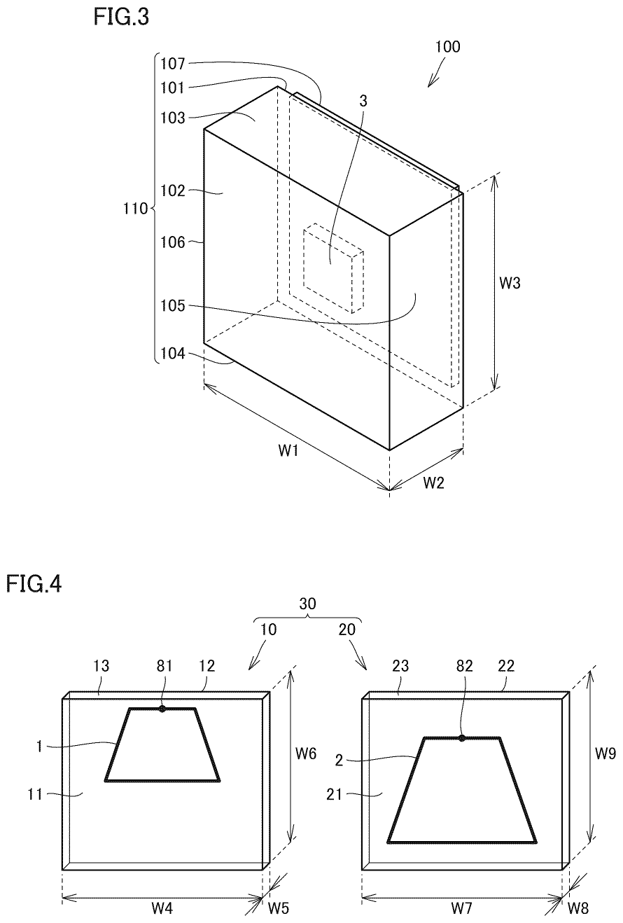

FIG. 3 is a schematic perspective view showing the configuration of radio wave sensor 100. As shown in FIG. 3, radio wave sensor 100 mainly has a radio wave transmission-reception substrate 3 and a casing 110. Radio wave transmission-reception substrate 3 is disposed inside casing 110. Radio wave transmission-reception substrate 3 is, for example, a millimeter-wave radar substrate for the 60 GHz band. The frequency of radio waves emitted from radio wave sensor 100 may be an arbitrary frequency that allows detection of vehicles etc., and is not limited to millimeter waves. Radio wave transmission-reception substrate 3 has, for example, a radio wave transmission antenna (not shown) and a radio wave reception antenna (not shown). The radio wave transmission antenna emits radio waves toward the detection target region. The radio wave reception antenna receives waves reflected from the detection target region. Thus, objects (specifically, vehicles) present in the detection target region are detected.

As shown in FIG. 3, casing 110 has a front surface 101, a back surface 102, an upper surface 103, a lower surface 104, a right-side surface 105, and a left-side surface 106. Front surface 101 normally faces the emission direction of radio waves. Back surface 102 is located on the opposite side from front surface 101. Lower surface 104 normally faces toward the ground surface. Lower surface 104 is located on the opposite side from upper surface 103. Right-side surface 105 is located on the opposite side from left-side surface 106. Casing 110 has a substantially rectangular parallelepiped shape. Upper surface 103 continues to front surface 101, back surface 102, right-side surface 105, and left-side surface 106. Similarly, lower surface 104 continues to front surface 101, back surface 102, right-side surface 105, and left-side surface 106. Front surface 101 may have a protruding part 107.

When the length of a borderline between back surface 102 and lower surface 104 is a first length W1, first length W1 is, for example, 245 mm. When the length of a borderline between lower surface 104 and right-side surface 105 is a second length W2, second length W2 is, for example, 50 mm or less. When the length of a borderline between front surface 101 and right-side surface 105 is a third length W3, third length W3 is, for example, 245 mm.

FIG. 4 is a schematic perspective view showing the configuration of sighting device 30 according to the first example. As shown in FIG. 4, sighting device 30 has first transparent member 10 and second transparent member 20. Second transparent member 20 is different from first transparent member 10. Each of first transparent member 10 and second transparent member 20 is, for example, a plate-like member. Each of first transparent member 10 and second transparent member 20 is, for example, an acrylic plate. Each of first transparent member 10 and second transparent member 20 is a member that transmits visible light. Each of first transparent member 10 and second transparent member 20 may be colored as long as it is transparent.

First transparent member 10 has a first principal surface 11, a second principal surface 12, and a first side surface 13. Second principal surface 12 is located on the opposite side from first principal surface 11. First side surface 13 continues to each of first principal surface 11 and second principal surface 12. While the shape of each of first principal surface 11 and second principal surface 12 is not particularly limited, it is, for example, a quadrangular shape. When the length of first transparent member 10 in a horizontal direction is a fourth length W4, and the length of first transparent member 10 in a vertical direction is a sixth length W6, sixth length W6 may be equal to fourth length W4. When the thickness of first transparent member 10 is a fifth length W5, fifth length W5 is smaller than each of fourth length W4 and sixth length W6.

Second transparent member 20 has a third principal surface 21, a fourth principal surface 22, and a second side surface 23. Fourth principal surface 22 is located on the opposite side from third principal surface 21. Second side surface 23 continues to each of third principal surface 21 and fourth principal surface 22. While the shape of each of third principal surface 21 and fourth principal surface 22 is not particularly limited, it is, for example, a quadrangular shape. When the length of second transparent member 20 in a horizontal direction is a seventh length W7, and the length of second transparent member 20 in a vertical direction is a ninth length W9, ninth length W9 may be equal to seventh length W7. When the thickness of second transparent member 20 is an eighth length W8, eighth length W8 is smaller than each of seventh length W7 and ninth length W9.

First transparent member 10 is provided with first sighting mark 1. First sighting mark 1 may be provided on first principal surface 11 or may be provided on second principal surface 12. While the shape of first sighting mark 1 is not particularly limited, it is, for example, a trapezoidal shape. First sighting mark 1 may be provided on first transparent member 10 in advance, or the worker himself or herself may provide first sighting mark 1 on first transparent member 10. In the case where the worker himself or herself provides first sighting mark 1 on first transparent member 10, first sighting mark 1 is provided on first transparent member 10 before the step of adjusting the direction of radio wave sensor 100 using sighting device 30. For example, first sighting mark 1 may be directly drawn on first transparent member 10 with a marker pen or the like, or may be printed on first transparent member 10.

First sighting mark 1 may be, for example, a trapezoidal sticker. This sticker may be attached to first transparent member 10. First sighting mark 1 may be, for example, one that is printed on a transparent overhead projector (OHP) film. First sighting mark 1 printed on an OHP film or the like may be attached to first transparent member 10. First sighting mark 1 may be a recess or a protrusion formed on first transparent member 10.

Second transparent member 20 is provided with second sighting mark 2. Second sighting mark 2 may be provided on third principal surface 21 or may be provided on fourth principal surface 22. While the shape of second sighting mark 2 is not particularly limited, it is, for example, a trapezoidal shape. Second sighting mark 2 may be provided on second transparent member 20 in advance, or the worker himself or herself may provide second sighting mark 2 on second transparent member 20. In the case where the worker himself or herself provides second sighting mark 2 on second transparent member 20, second sighting mark 2 is provided on second transparent member 20 before the step of adjusting the direction of radio wave sensor 100 using sighting device 30. For example, second sighting mark 2 may be directly drawn on second transparent member 20 with a marker pen or the like, or may be printed on second transparent member 20.

Second sighting mark 2 may be, for example, a trapezoidal sticker. This sticker may be attached to second transparent member 20. Second sighting mark 2 may be, for example, one that is printed on a transparent overhead projector (OHP) film. Second sighting mark 2 printed on an OHP film or the like may be attached to second transparent member 20. Second sighting mark 2 may be a recess or a protrusion formed on second transparent member 20.

First sighting mark 1 may have first sighting point 81. First sighting point 81 may be the midpoint of the upper base of the trapezoid. Similarly, second sighting mark 2 may have second sighting point 82. Second sighting point 82 may be the midpoint of the upper base of the trapezoid. Consequently, setting the sighting point on the upper base, and not on the lower base, allows aiming at a far reference point. Accordingly, the accuracy of adjusting the direction of radio wave sensor 100 can be improved. As shown in FIG. 4, the worker may add a point with a marker pen to each of first sighting point 81 and second sighting point 82.

FIG. 5 is a schematic view showing a state where first transparent member 10 and second transparent member 20 are overlapped. In FIG. 5, first transparent member 10 and second transparent member 20 are overlapped such that second principal surface 12 of first transparent member 10 contacts third principal surface 21 of second transparent member 20. As shown in FIG. 5, second sighting mark 2 has a shape that encompasses first sighting mark 1 when seen in a direction from first transparent member 10 toward second transparent member 20 in the state where first transparent member 10 and second transparent member 20 are overlapped. From another perspective, second sighting mark 2 surrounds first sighting mark 1. First sighting mark 1 and second sighting mark 2 may have similar shapes but need not necessarily have similar shapes.

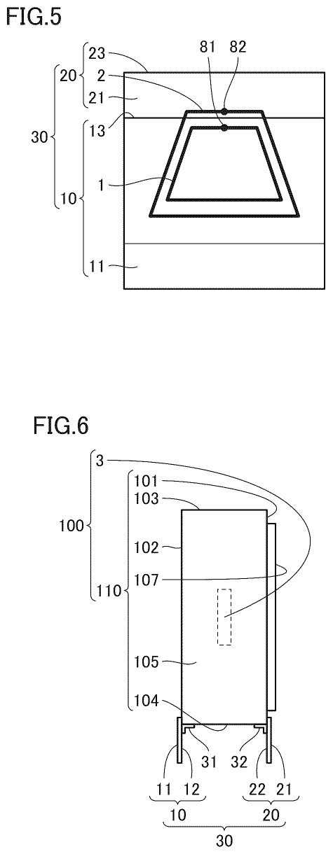

FIG. 6 is a schematic side view showing the step of mounting sighting device 30 onto radio wave sensor 100. As shown in FIG. 6, each of first transparent member 10 and second transparent member 20 is mounted onto casing 110 of radio wave sensor 100. Second principal surface 12 of first transparent member 10 is disposed, for example, in contact with a lower part of back surface 102 of casing 110. First transparent member 10 is fixed to casing 110 using a first fixing member 31. First fixing member 31 may have an L-shape as seen in cross-section. First fixing member 31 is mounted onto first transparent member 10. First fixing member 31 is mounted, for example, onto lower surface 104 of casing 110. Second principal surface 12 is substantially parallel to back surface 102. Second principal surface 12 is substantially perpendicular to lower surface 104 of casing 110.

Fourth principal surface 22 of second transparent member 20 is disposed, for example, in contact with a lower part of front surface 101 of casing 110. Second transparent member 20 is fixed to casing 110 using a second fixing member 32. Second fixing member 32 may have an L-shape as seen in cross-section. Second fixing member 32 is mounted onto second transparent member 20. Second fixing member 32 is mounted, for example, onto lower surface 104 of casing 110. Fourth principal surface 22 is substantially parallel to front surface 101. Fourth principal surface 22 is substantially perpendicular to lower surface 104 of casing 110. Thus, sighting device 30 is mounted onto radio wave sensor 100.

Next, the step of adjusting the direction of radio wave sensor 100 using sighting device 30 (S20) is performed.

FIG. 7 is a schematic side view showing the step of adjusting the direction of radio wave sensor 100 using sighting device 30. First, radio wave sensor 100 is temporarily fixed to support member 40. Support member 40 has, for example, a first support part 41, a second support part 42, and a third fixing member 43. First support part 41 is mounted on second support part 42. Radio wave sensor 100 is mounted on first support part 41 using third fixing member 43. Radio wave sensor 100 may be turnable in a rotation direction around a central axis of third fixing member 43. Thus, the direction of radio wave sensor 100 (first direction D1) can be adjusted. First direction D1 is, for example, perpendicular to front surface 101 of casing 110. First direction D1 is, for example, parallel to lower surface 104 of casing 110. As shown in FIG. 7, a point of view 4 of the worker is located on the opposite side of first transparent member 10 from second transparent member 20. In the state where first transparent member 10 and second transparent member 20 are disposed facing each other, the worker looks from a position located on the opposite side of first transparent member 10 from second transparent member 20. The direction of a line of sight of the worker is a direction from first transparent member 10 toward second transparent member 20 (second direction D2). The worker observes a region constituting a detection target through first transparent member 10 and second transparent member 20. Specifically, the worker finds a reference point through first transparent member 10 and second transparent member 20. First transparent member 10 is disposed between the point of view 4 of the worker and second transparent member 20. Second transparent member 20 is disposed between first transparent member 10 and the reference point.

FIG. 8 is a schematic view showing a state where a region constituting a detection target is observed through first transparent member 10 and second transparent member 20. As shown in FIG. 8, the worker adjusts the direction of radio wave sensor 100 using first sighting mark 1 indicated on first transparent member 10 and second sighting mark 2 indicated on second transparent member 20. A direction from first sighting point 81 on first sighting mark 1 toward second sighting point 82 on second sighting mark 2 is a sighting direction (second direction D2). As shown in FIG. 1, the direction of radio wave sensor 100 is adjusted such that the sighting direction (second direction D2) is oriented toward second point P2 that is the reference point. Specifically, the direction of radio wave sensor 100 is adjusted such that first sighting point 81 on first sighting mark 1, second sighting point 82 on second sighting mark 2, and the reference point are aligned in a straight line. From another perspective, the direction of radio wave sensor 100 is adjusted such that first sighting point 81, second sighting point 82, and the reference point overlap when seen from the worker (see FIG. 1, FIG. 7, and FIG. 8).

A color cone (TM), for example, may be disposed at the reference point to help the worker's observation. The position of the reference point is not particularly limited. The position of the reference point may be a point on a median strip 9, or may be a point on a road shoulder 8, or may be a point on a road 7. Thus, the direction of radio wave sensor 100 is adjusted using sighting device 30.

Next, the step of fixing the direction of radio wave sensor 100 (S30) is performed. After the adjustment of the direction of radio wave sensor 100 is completed, the direction of radio wave sensor 100 is fixed. As shown in FIG. 7, radio wave sensor 100 is fixed to support member 40, for example, using third fixing member 43 such that the direction of radio wave sensor 100 does not change. Third fixing member 43 may be, for example, a fixing screw. Thus, radio wave sensor 100 is firmly fixed by third fixing member 43 such that the direction of radio wave sensor 100 does not change.

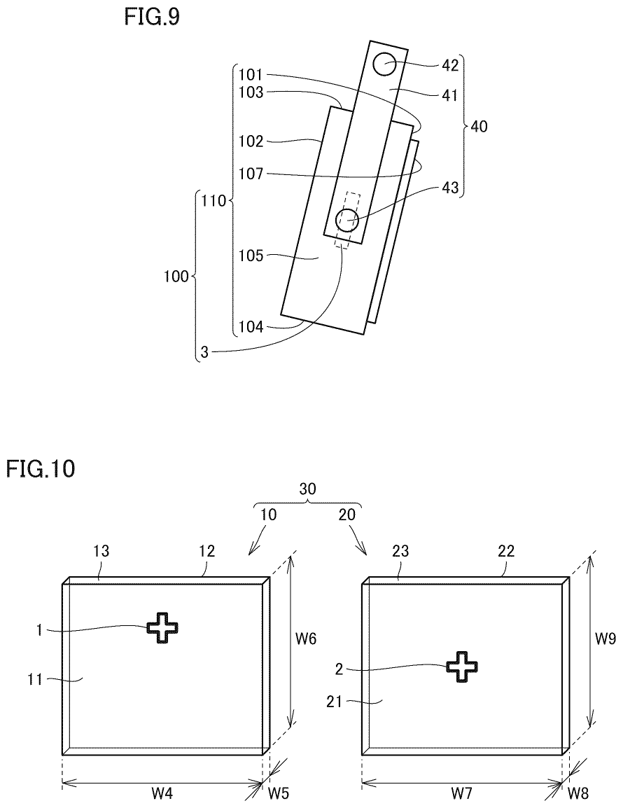

Next, the step of removing sighting device 30 from radio wave sensor 100 (S40) is performed. FIG. 9 is a schematic side view showing the step of removing sighting device 30 from radio wave sensor 100. As shown in FIG. 9, first transparent member 10 is removed from radio wave sensor 100 along with first fixing member 31. Similarly, second transparent member 20 is removed from radio wave sensor 100 along with second fixing member 32. Thus, sighting device 30 is removed from radio wave sensor 100. This completes the installation of radio wave sensor 100 onto support member 40.

While the case where each of first transparent member 10 and second transparent member 20 is an acrylic plate has been described above, each of first transparent member 10 and second transparent member 20 is not limited to an acrylic plate. At least one of first transparent member 10 and second transparent member 20 may be a see-through display. In this case, first sighting mark 1 or second sighting mark 2 may be displayed on the see-through-side display. One of first transparent member 10 and second transparent member 20 may be an acrylic plate, and the other of first transparent member 10 and second transparent member 20 may be a see-through display.

In the step of adjusting the direction of radio wave sensor 100 using sighting device 30 (S20), first sighting mark 1 may be displayed on first transparent member 10 by being projected onto first transparent member 10 using a projector (not shown), for example. Similarly, in the step of adjusting direction of radio wave sensor 100 using sighting device 30 (S20), second sighting mark 2 may be displayed on second transparent member 20 by being projected onto second transparent member 20 using a projector, for example. The sighting mark may be projected onto one of first transparent member 10 and second transparent member 20 using a projector, and the sighting mark may be displayed on the other of first transparent member 10 and second transparent member 20 by a see-through display.

While the case where sighting device 30 has two transparent members has been described above, sighting device 30 may have three or more transparent members. Sighting device 30 may have, for example, a third transparent member (not shown). The third transparent member may be provided with a third sighting mark (not shown).

### Second Embodiment

Next, an installation method of radio wave sensor 100 according to a second embodiment of the present disclosure will be described. The installation method of radio wave sensor 100 according to the second embodiment is different from the installation method of radio wave sensor 100 according to the first embodiment mainly in that the shape of each of first sighting mark 1 and second sighting mark 2 is a cross pattern, and is the same as the installation method of radio wave sensor 100 according to the first embodiment in other respects. In the following, description will be given with a focus on the difference from the installation method of radio wave sensor 100 according to the first embodiment.

FIG. 10 is a schematic perspective view showing the configuration of sighting device 30 according to the second example. As shown in FIG. 10, first transparent member 10 is provided with first sighting mark 1. First sighting mark 1 is a cross pattern. Second transparent member 20 is provided with second sighting mark 2. Second sighting mark 2 is a cross pattern.

Second sighting mark 2 overlaps first sighting mark 1 when seen in a direction from first transparent member 10 toward second transparent member 20 in a state where first transparent member 10 and second transparent member 20 are overlapped. From another perspective, first sighting mark 1 and second sighting mark 2 may have the same shape. First sighting mark 1 and second sighting mark 2 may have similar shapes.

According to the installation method of radio wave sensor 100 as described in the second embodiment, in the step of adjusting the direction of radio wave sensor 100 using sighting device 30 (S20), the direction of radio wave sensor 100 may be adjusted such that the shape of first sighting mark 1 overlaps the shape of second sighting mark 2. Specifically, the direction of radio wave sensor 100 is adjusted such that, when the worker looks in the direction of second transparent member 20 from first transparent member 10, the outline of a first cross pattern provided on first transparent member 10 and the outline of a second cross pattern provided on second transparent member 20 coincide with each other.

In the step of adjusting the direction of radio wave sensor 100 using sighting device 30 (S20), the direction of radio wave sensor 100 is adjusted such that the first cross pattern, the second cross pattern, and the reference point are aligned in a straight line. From another perspective, the direction of radio wave sensor 100 is adjusted such that the first cross pattern, the second cross pattern, and the reference point overlap when seen from the worker.

### Third Embodiment

Next, an installation method of radio wave sensor 100 according to a third embodiment of the present disclosure will be described. The installation method of radio wave sensor 100 according to the third embodiment is different from the installation method of radio wave sensor 100 according to the first embodiment mainly in that the shape of each of first sighting mark 1 and second sighting mark 2 is a graph-paper pattern, and is the same as the installation method of radio wave sensor 100 according to the first embodiment in other respects. In the following, description will be given with a focus on the difference from the installation method of radio wave sensor 100 according to the first embodiment.

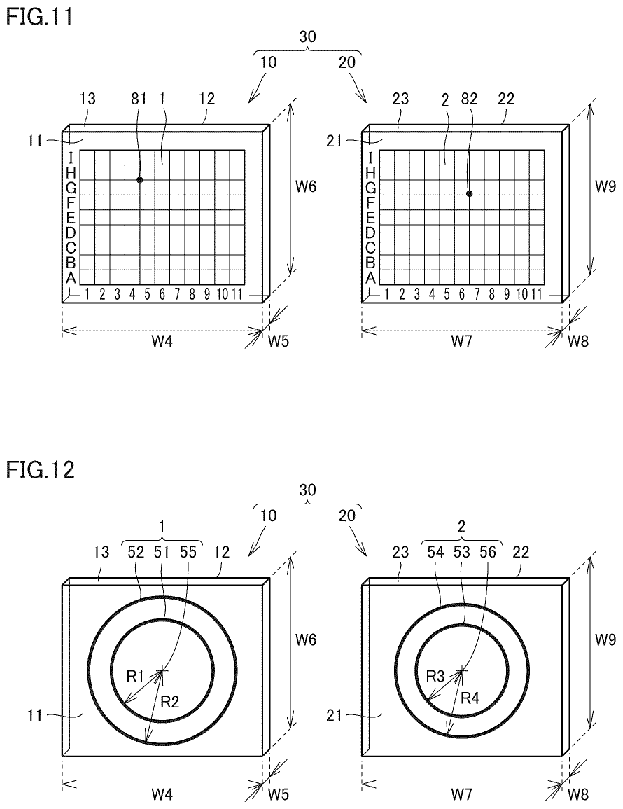

FIG. 11 is a schematic perspective view showing the configuration of sighting device 30 according to the third example. As shown in FIG. 11, first transparent member 10 is provided with first sighting mark 1. First sighting mark 1 is a first graph-paper pattern. Second transparent member 20 is provided with second sighting mark 2. Second sighting mark 2 is a second graph-paper pattern. Each of first principal surface 11 and third principal surface 21 has, for example, a rectangular shape.

Each of the first graph-paper pattern and the second graph-paper pattern is composed of, for example, a plurality of parallel line segments that extends along a long-side direction of the rectangle and is disposed at regular intervals, and a plurality of parallel line segments that extends along a short-side direction and is disposed at regular intervals. Points of intersection between the line segments extending in the long-side direction and the line segments extending in the short-side direction are grid points. The first graph-paper pattern has a plurality of first grid points. The second graph-paper pattern has a plurality of second grid points. Each of the first graph-paper pattern and the second graph-paper pattern may be a logarithmic graph-paper or hexagonal-sheet pattern. The pattern of each of first sighting mark 1 and second sighting mark 2 may be a fan shape. This pattern may be a polar coordinate pattern combining straight lines extending radially from a pivot (center point) and arcs.

At a lower-side part of each of the first graph-paper pattern and the second graph-paper pattern, numbers may be indicated at positions corresponding to the respective line segments. Similarly, at a left-side part of each of the first graph-paper pattern and the second graph-paper pattern, alphabets may be indicated at positions corresponding to the respective line segments. Thus, the position of each grid point can be easily specified.

The method may further have a step of drawing a mark at each of the first grid point and the second grid point before the step of adjusting the direction of radio wave sensor 100 using sighting device 30. For example, the worker is notified of a coordinate of the first grid point and a coordinate of the second grid point. The coordinate of the first grid point is specified by the number and the alphabet provided on first transparent member 10. The worker draws a mark at the first grid point specified by the number and the alphabet using a marker pen, for example. The first grid point of the first graph-paper pattern is, for example, first sighting point 81.

Similarly, the coordinate of the second grid point is specified by the number and the alphabet provided on second transparent member 20. The worker draws a mark at the second grid point specified by the number and the alphabet using a marker pen, for example. The second grid point of the second graph-paper pattern is, for example, second sighting point 82.

According to the installation method of radio wave sensor 100 as described in the third embodiment, in the step of adjusting the direction of radio wave sensor 100 using sighting device 30 (S20), the direction of radio wave sensor 100 is adjusted such that the first grid point on first sighting mark 1, the second grid point on second sighting mark 2, and the reference point are aligned in a straight line. From another perspective, the direction of radio wave sensor 100 is adjusted such that the first grid point, the second grid point, and the reference point overlap when seen from the worker.

### Fourth Embodiment

Next, an installation method of radio wave sensor 100 according to a fourth embodiment of the present disclosure will be described. The installation method of radio wave sensor 100 according to the fourth embodiment is different from the installation method of radio wave sensor 100 according to the first embodiment mainly in that the shape of each of first sighting mark 1 and second sighting mark 2 is a concentric-circle pattern, and is the same as the installation method of radio wave sensor 100 according to the first embodiment in other respects. In the following, description will be given with a focus on the difference from the installation method of radio wave sensor 100 according to the first embodiment.

FIG. 12 is a schematic perspective view showing the configuration of sighting device 30 according to the fourth example. As shown in FIG. 12, first transparent member 10 is provided with first sighting mark 1. First sighting mark 1 is a first concentric-circle pattern. Second transparent member 20 is provided with second sighting mark 2. Second sighting mark 2 is a second concentric-circle pattern.

As shown in FIG. 12, first sighting mark 1 has a first circle 51, a second circle 52, and a first center part 55. The radius of first circle 51 is a first radius R1. The radius of second circle 52 is a second radius R2. Second radius R2 is larger than first radius R1. The center of each of first circle 51 and second circle 52 is first center part 55. From another perspective, the center of first circle 51 and the center of second circle 52 coincide with each other. First center part 55 may be a plus mark.

Second sighting mark 2 has a third circle 53, a fourth circle 54, and a second center part 56. The radius of third circle 53 is a third radius R3. The radius of fourth circle 54 is a fourth radius R4. Fourth radius R4 is larger than third radius R3. The center of each of third circle 53 and fourth circle 54 is second center part 56. From another perspective, the center of third circle 53 and the center of fourth circle 54 coincide with each other. Second center part 56 may be a plus mark. Third radius R3 may be smaller than the first radius R1 or may be equal to first radius R1. Fourth radius R4 may be smaller than second radius R2 or may be equal to second radius R2.

According to the installation method of radio wave sensor 100 as described in the fourth embodiment, in the step of adjusting the direction of radio wave sensor 100 using sighting device 30 (S20), the direction of radio wave sensor 100 may be adjusted such that first circle 51 overlaps third circle 53. Specifically, the direction of radio wave sensor 100 is adjusted such that first circle 51 provided on first transparent member 10 surrounds third circle 53 provided on second transparent member 20 and that the reference point is included inside third circle 53 when the worker looks in the direction of second transparent member 20 from first transparent member 10.

In the step of adjusting the direction of radio wave sensor 100 using sighting device 30 (S20), the direction of radio wave sensor 100 may be adjusted such that first center part 55 on first sighting mark 1, second center part 56 on second sighting mark 2, and the reference point are aligned in a straight line. From another perspective, the direction of radio wave sensor 100 may be adjusted such that first center part 55, second center part 56, and the reference point overlap when seen from the worker.

### Fifth Embodiment

Next, an installation method of radio wave sensor 100 according to a fifth embodiment of the present disclosure will be described. The installation method of radio wave sensor 100 according to the fifth embodiment is different from the installation method of radio wave sensor 100 according to each of the first embodiment to the fourth embodiment mainly in that, in the step of mounting sighting device 30 onto radio wave sensor 100, first positioning mark 60 of radio wave sensor 100 is aligned with second positioning mark 70 of first transparent member 10, and is the same as the installation method of radio wave sensor 100 according to each of the first embodiment to the fourth embodiment in other respects. In the following, description will be given with a focus on the difference from the installation method of radio wave sensor 100 according to each of the first embodiment to the fourth embodiment.

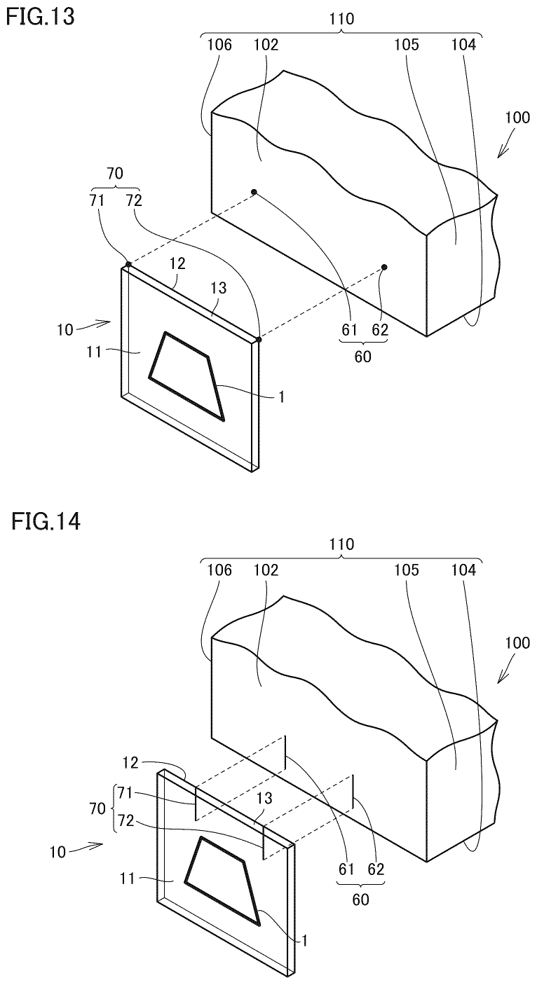

FIG. 13 is a schematic perspective view showing a first modified example of the step of mounting sighting device 30 onto radio wave sensor 100. As shown in FIG. 13, radio wave sensor 100 may be provided with first positioning mark 60. First positioning mark 60 has, for example, a first mark part 61 and a second mark part 62. Each of first mark part 61 and second mark part 62 is, for example, a point. First positioning mark 60 is provided, for example, on back surface 102 of casing 110. First positioning mark 60 may be provided, for example, on a surface of casing 110 other than back surface 102.

First transparent member 10 may be provided with second positioning mark 70. Second positioning mark 70 has, for example, a third mark part 71 and a fourth mark part 72. Each of third mark part 71 and fourth mark part 72 is, for example, a point. Second positioning mark 70 is provided, for example, at upper corners of second principal surface 12 of first transparent member 10. Second positioning mark 70 may be provided, for example, at corners of a surface of first transparent member 10 other than second principal surface 12.

In the step of mounting sighting device 30 onto radio wave sensor 100 (S10), first positioning mark 60 is aligned with second positioning mark 70. Specifically, first mark part 61 is aligned with third mark part 71, and second mark part 62 is aligned with fourth mark part 72. Thus, first transparent member 10 is positioned relative to casing 110 of radio wave sensor 100. First transparent member 10 is fixed to casing 110 using, for example, a magnet, a screw, or a double-sided tape. Second transparent member 20 may be mounted onto casing 110 of radio wave sensor 100 using the same method. Second transparent member 20 is mounted, for example, onto front surface 101 of casing 110 of radio wave sensor 100.

### Sixth Embodiment

Next, an installation method of radio wave sensor 100 according to a sixth embodiment of the present disclosure will be described. The installation method of radio wave sensor 100 according to the sixth embodiment is different from the installation method of radio wave sensor 100 according to the fifth embodiment mainly in that each of first positioning mark 60 and second positioning mark 70 has a linear shape, and is the same as the installation method of radio wave sensor 100 according to the fifth embodiment in other respects. In the following, description will be given with a focus on the difference from the installation method of radio wave sensor 100 according to the fifth embodiment.

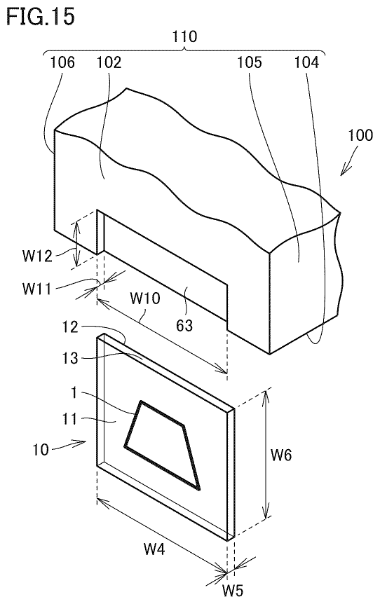

FIG. 14 is a schematic perspective view showing a second modified example of the step of mounting sighting device 30 onto radio wave sensor 100. As shown in FIG. 14, first positioning mark 60 has, for example, first mark part 61 and second mark part 62. Each of first mark part 61 and second mark part 62 has a linear shape. First mark part 61 and second mark part 62 may be parallel. First positioning mark 60 is provided, for example, on back surface 102 of casing 110. First positioning mark 60 may be provided, for example, on a surface of casing 110 other than back surface 102.

Second positioning mark 70 has, for example, third mark part 71 and fourth mark part 72. Each of third mark part 71 and fourth mark part 72 has a linear shape. First mark part 61 and second mark part 62 may be parallel. Second positioning mark 70 is provided, for example, on second principal surface 12 of first transparent member 10. Second positioning mark 70 may be provided, for example, on a surface of first transparent member 10 other than second principal surface 12.

In the step of mounting sighting device 30 onto radio wave sensor 100 (S10), first positioning mark 60 is aligned with second positioning mark 70. Specifically, first mark part 61 is aligned with third mark part 71, and second mark part 62 is aligned with fourth mark part 72. Thus, first transparent member 10 is positioned relative to casing 110 of radio wave sensor 100. First transparent member 10 is fixed to casing 110 using, for example, a magnet, a screw, or a double-sided tape. Second transparent member 20 may be mounted onto casing 110 of radio wave sensor 100 using the same method. Second transparent member 20 is mounted, for example, onto front surface 101 of casing 110 of radio wave sensor 100.

### Seventh Embodiment

Next, an installation method of radio wave sensor 100 according to a seventh embodiment of the present disclosure will be described. The installation method of radio wave sensor 100 according to the seventh embodiment is different from the installation method of radio wave sensor 100 according to each of the first embodiment to the fourth embodiment mainly in that, in the step of mounting sighting device 30 onto radio wave sensor 100, first transparent member 10 is fitted into recess 63 provided in casing 110 of radio wave sensor 100, and is the same as the installation method of radio wave sensor 100 according to each of the first embodiment to the fourth embodiment in other respects. In the following, description will be given with a focus on the difference from the installation method of radio wave sensor 100 according to each of the first embodiment to the fourth embodiment.

FIG. 15 is a schematic perspective view showing a third modified example of the step of mounting sighting device 30 onto radio wave sensor 100. As shown in FIG. 15, casing 110 of radio wave sensor 100 may be provided with recess 63. Recess 63 is provided, for example, so as to be exposed in each of back surface 102 and lower surface 104 of casing 110. The length of recess 63 in a direction parallel to a borderline between lower surface 104 and back surface 102 of casing 110 is a tenth length W10. The length of recess 63 in a direction parallel to a borderline between lower surface 104 and right-side surface 105 of casing 110 is an eleventh length W11. The length of recess 63 in a direction parallel to a borderline between back surface 102 and right-side surface 105 of casing 110 is a twelfth length W12.

Tenth length W10 is almost equal to fourth length W4. Eleventh length W11 is almost equal to fifth length W5. Twelfth length W12 may be shorter than sixth length W6. In the step of mounting sighting device 30 onto radio wave sensor 100 (S10), first transparent member 10 may be fitted into recess 63. Thus, first transparent member 10 is fixed in a state of being positioned relative to casing 110. First transparent member 10 is mounted onto casing 110 such that part of first transparent member 10 is disposed inside recess 63 while the rest of first transparent member 10 is located outside recess 63. Second transparent member 20 may be mounted onto casing 110 of radio wave sensor 100 using the same method. Second transparent member 20 is mounted, for example, onto front surface 101 of casing 110 of radio wave sensor 100.

### Eighth Embodiment

Next, an installation method of radio wave sensor 100 according to an eighth embodiment of the present disclosure will be described. The installation method of radio wave sensor 100 according to the eighth embodiment is different from the installation method of radio wave sensor 100 according to each of the first embodiment to the fourth embodiment mainly in that, in the step of mounting sighting device 30 onto radio wave sensor 100, a projecting part 80 provided on casing 110 of radio wave sensor 100 is inserted into a hole 90 provided in first transparent member 10, and is the same as the installation method of radio wave sensor 100 according to each of the first embodiment to the fourth embodiment in other respects. In the following, description will be given with a focus on the difference from the installation method of radio wave sensor 100 according to each of the first embodiment to the fourth embodiment.

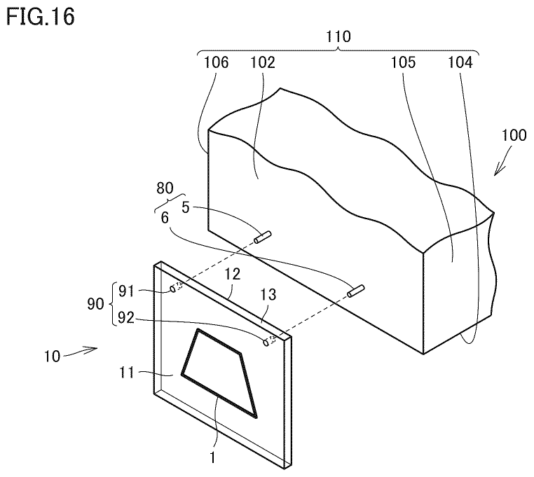

FIG. 16 is a schematic perspective view showing a fourth modified example of the step of mounting sighting device 30 onto radio wave sensor 100. As shown in FIG. 16, casing 110 of radio wave sensor 100 may be provided with projecting part 80. Projecting part 80 has, for example, a first projection 5 and a second projection 6. Each of first projection 5 and second projection 6 is provided, for example, on back surface 102 of casing 110. Each of first projection 5 and second projection 6 extends, for example, in a direction perpendicular to back surface 102 of casing 110.

First transparent member 10 may be provided with hole 90. Hole 90 has, for example, a first hole part 91 and a second hole part 92. Each of first hole part 91 and second hole part 92 is, for example, a through-hole opening in each of first principal surface 11 and second principal surface 12. Each of first hole part 91 and second hole part 92 may be, for example, a blind hole that opens only in second principal surface 12.

In the step of mounting sighting device 30 onto radio wave sensor 100 (S10), projecting part 80 provided on casing 110 of radio wave sensor 100 is inserted into hole 90 provided in first transparent member 10. Specifically, first projection 5 is inserted into first hole part 91, and second projection 6 is inserted into second hole part 92. Thus, first transparent member 10 is positioned relative to casing 110 of radio wave sensor 100. Second transparent member 20 may be positioned to casing 110 of radio wave sensor 100 using the same method. Second transparent member 20 is mounted, for example, onto front surface 101 of casing 110 of radio wave sensor 100.

While the form in which first transparent member 10 is provided with hole 90 and casing 110 of radio wave sensor 100 is provided with projecting part 80 has been described in the installation method of radio wave sensor 100 according to the eighth embodiment, the installation method of radio wave sensor 100 according to the eighth embodiment is not limited to this form. For example, first transparent member 10 may be provided with projecting part 80, and casing 110 of radio wave sensor 100 may be provided with hole 90.

While the case where first transparent member 10 is disposed on back surface 102 of casing 110 and second transparent member 20 is disposed on front surface 101 of casing 110 has been described in the installation methods of radio wave sensor 100 according to the first embodiment to the eighth embodiment, the present disclosure is not limited to the case where first transparent member 10 is disposed on back surface 102 of casing 110 and second transparent member 20 is disposed on front surface 101 of casing 110. For example, first transparent member 10 may be disposed on right-side surface 105 of casing 110 and second transparent member 20 may be disposed on left-side surface 106 of casing 110, or first transparent member 10 may be disposed on lower surface 104 of casing 110 and second transparent member 20 may be disposed on upper surface 103 of casing 110.

### Ninth Embodiment

Next, an installation method of radio wave sensor 100 according to a ninth embodiment of the present disclosure will be described. The installation method of radio wave sensor 100 according to the ninth embodiment is different from the installation method of radio wave sensor 100 according to the fifth embodiment mainly in that first transparent member 10 has a first bent part 14 and that first bent part 14 contacts right-side surface 105 of casing 110, and is the same as the installation method of radio wave sensor 100 according to the fifth embodiment in other respects. In the following, description will be given with a focus on the difference from the installation method of radio wave sensor 100 according to the fifth embodiment.

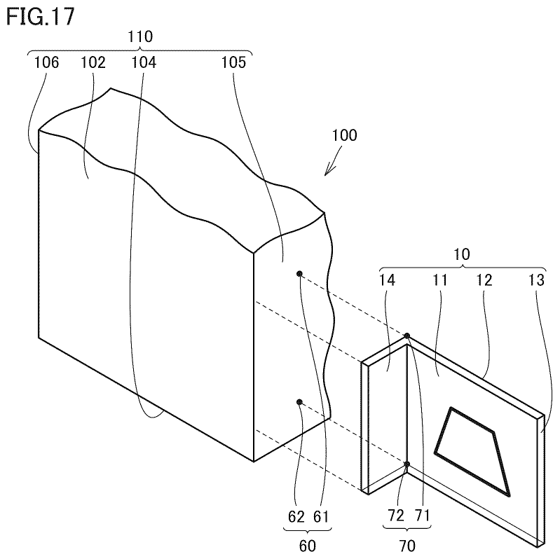

FIG. 17 is a schematic perspective view showing a fifth modified example of the step of mounting sighting device 30 onto radio wave sensor 100. As shown in FIG. 17, first transparent member 10 may have first bent part 14. First bent part 14 may be formed as part of first transparent member 10 is bent. First bent part 14 may be perpendicular to first principal surface 11.

Casing 110 of radio wave sensor 100 may be provided with first positioning mark 60. First positioning mark 60 has, for example, first mark part 61 and second mark part 62. Each of first mark part 61 and second mark part 62 is, for example, a point. First positioning mark 60 is provided, for example, on right-side surface 105 of casing 110.

First transparent member 10 may be provided with second positioning mark 70. Second positioning mark 70 has, for example, third mark part 71 and fourth mark part 72. Each of third mark part 71 and fourth mark part 72 is, for example, a point.

Second positioning mark 70 is provided, for example, at points of contact between each of two corners of second principal surface 12 of first transparent member 10 and first bent part 14.

In the step of mounting sighting device 30 onto radio wave sensor 100 (S10), first positioning mark 60 is aligned with second positioning mark 70. Specifically, first mark part 61 is aligned with third mark part 71, and second mark part 62 is aligned with fourth mark part 72. First bent part 14 contacts right-side surface 105 of casing 110. Thus, first transparent member 10 is positioned relative to casing 110 of radio wave sensor 100. First transparent member 10 is fixed to casing 110 using, for example, a magnet, a screw, or a double-sided tape. Second transparent member 20 may be mounted onto casing 110 of radio wave sensor 100 using the same method. Second transparent member 20 may be mounted onto right-side surface 105 of casing 110 of radio wave sensor 100.

### Tenth Embodiment

Next, an installation method of radio wave sensor 100 according to a tenth embodiment of the present disclosure will be described. The installation method of radio wave sensor 100 according to the tenth embodiment is different from the installation method of radio wave sensor 100 according to the fifth embodiment mainly in that second transparent member 20 has a second bent part 24 and that second bent part 24 contacts lower surface 104 of casing 110, and is the same as the installation method of radio wave sensor 100 according to the fifth embodiment in other respects. In the following, description will be given with a focus on the difference from the installation method of radio wave sensor 100 according to the fifth embodiment.

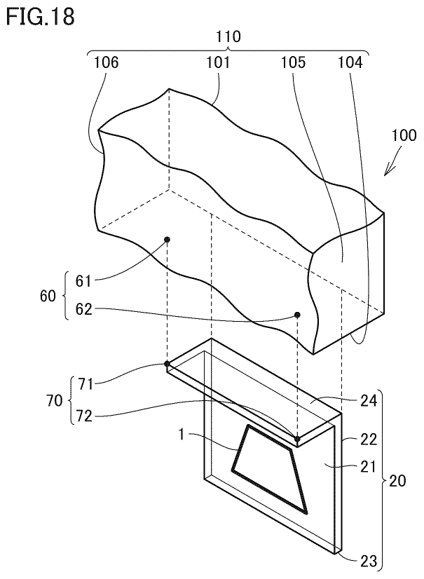

FIG. 18 is a schematic perspective view showing a sixth modified example of the step of mounting sighting device 30 onto radio wave sensor 100. As shown in FIG. 18, second transparent member 20 may have second bent part 24. Second bent part 24 may be formed as part of second transparent member 20 is bent. Second bent part 24 may be perpendicular to third principal surface 21.

Casing 110 of radio wave sensor 100 may be provided with first positioning mark 60. First positioning mark 60 has, for example, first mark part 61 and second mark part 62. Each of first mark part 61 and second mark part 62 is, for example, a point. First positioning mark 60 is provided, for example, on lower surface 104 of casing 110.

Second transparent member 20 may be provided with second positioning mark 70. Second positioning mark 70 has, for example, third mark part 71 and fourth mark part 72. Each of third mark part 71 and fourth mark part 72 is, for example, a point. Second positioning mark 70 is provided, for example, at each of both corners of second bent part 24 located on the opposite side from a borderline between third principal surface 21 and second bent part 24 of second transparent member 20.

In the step of mounting sighting device 30 onto radio wave sensor 100 (S10), first positioning mark 60 is aligned with second positioning mark 70. Specifically, first mark part 61 is aligned with third mark part 71, and second mark part 62 is aligned with fourth mark part 72. Second bent part 24 contacts lower surface 104 of casing 110. Thus, second transparent member 20 is positioned relative to casing 110 of radio wave sensor 100. Second transparent member 20 is fixed to casing 110 using, for example, a magnet, a screw, or a double-sided tape. First transparent member 10 may be mounted to casing 110 of radio wave sensor 100 using the same method. First transparent member 10 may be mounted onto lower surface 104 of casing 110 of radio wave sensor 100.

### Eleventh Embodiment

Next, an installation method of radio wave sensor 100 according to an eleventh embodiment of the present disclosure will be described. The installation method of radio wave sensor 100 according to the eleventh embodiment is different from the installation method of radio wave sensor 100 according to each of the first embodiment to the fourth embodiment mainly in that, in the step of mounting sighting device 30 onto radio wave sensor 100, a straight line along the emission direction of radio waves and a straight line along the sighting direction of sighting device 30 are skew, and is the same as the installation method of radio wave sensor 100 according to each of the first embodiment to the fourth embodiment in other respects. In the following, description will be given with a focus on the difference from the installation method of radio wave sensor 100 according to each of the first embodiment to the fourth embodiment.

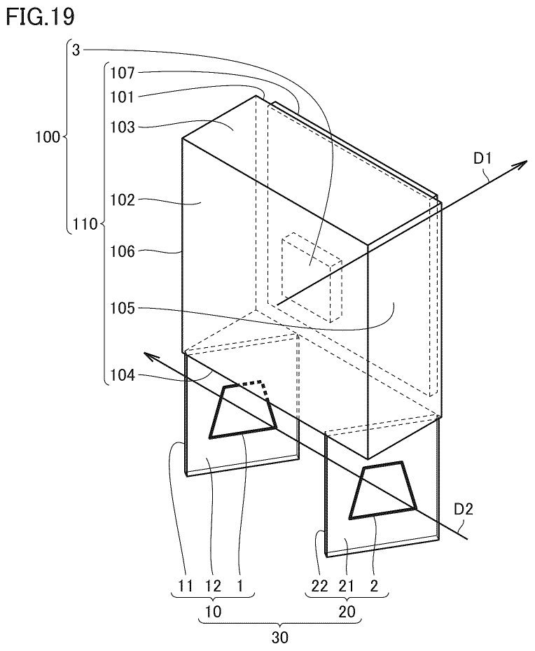

FIG. 19 is a schematic perspective view showing a seventh modified example of the step of mounting sighting device 30 onto radio wave sensor 100. As shown in FIG. 19, each of first transparent member 10 and second transparent member 20 is mounted on lower surface 104 of casing 110 of radio wave sensor 100. A straight line connecting first sighting mark 1 and second sighting mark 2 and a straight line along the direction of radio wave sensor 100 (first direction D1) may be skew. First direction D1 is the emission direction of radio waves. A direction along the straight line connecting first sighting mark 1 and second sighting mark 2 may coincide with the sighting direction of sighting device 30.

From another perspective, a straight line perpendicular to first principal surface 11 of first transparent member 10 and a straight line perpendicular to front surface 101 of casing 110 may be skew. From yet another perspective, first principal surface 11 of first transparent member 10 may be inclined relative to a straight line parallel to each of right-side surface 105, left-side surface 106, front surface 101, back surface 102, upper surface 103, and lower surface 104 of casing 110. Similarly, third principal surface 21 of second transparent member 20 may be inclined relative to a straight line parallel to each of right-side surface 105, left-side surface 106, front surface 101, back surface 102, upper surface 103, and lower surface 104 of casing 110.

### Twelfth Embodiment

Next, an installation method of radio wave sensor 100 according to a twelfth embodiment of the present disclosure will be described. The installation method of radio wave sensor 100 according to the twelfth embodiment is different from the installation method of radio wave sensor 100 according to each of the first embodiment to the fourth embodiment mainly in that each of first transparent member 10 and second transparent member 20 has a shape conforming to the shape of a road constituting a detection target, and is the same as the installation method of radio wave sensor 100 according to each of the first embodiment to the fourth embodiment in other respects. In the following, description will be given with a focus on the difference from the installation method of radio wave sensor 100 according to each of the first embodiment to the fourth embodiment.

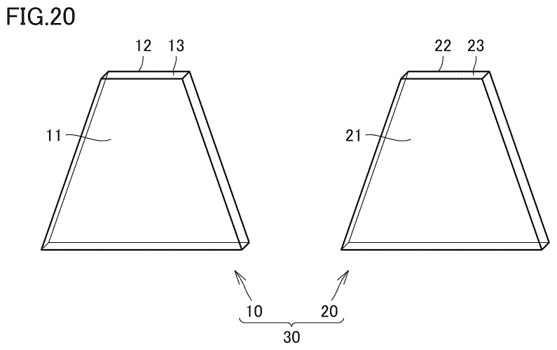

FIG. 20 is a schematic perspective view showing the configuration of sighting device 30 according to the fifth example. As shown in FIG. 20, sighting device 30 has first transparent member 10 and second transparent member 20. First transparent member 10 has first principal surface 11, second principal surface 12, and first side surface 13. First transparent member 10 need not necessarily be provided with first sighting mark 1. Second transparent member 20 has third principal surface 21, fourth principal surface 22, and second side surface 23. Second transparent member 20 need not necessarily be provided with second sighting mark 2.

First transparent member 10 has a shape conforming to the shape of a road constituting the detection target. When the shape of the road shape extends in a straight line, the shape of each of first principal surface 11 and second principal surface 12 may be, for example, a trapezoidal shape. When the shape of the road shape is curved, the shape of each of first principal surface 11 and second principal surface 12 may be, for example, a parallelogram. Before the step of mounting sighting device 30 onto radio wave sensor 100, first transparent member 10 having a shape conforming to the shape of a road constituting the detection target is selected.

Similarly, second transparent member 20 has a shape conforming to the shape of a road constituting the detection target. When the shape of the road shape extends in a straight line, the shape of each of third principal surface 21 and fourth principal surface 22 may be, for example, a trapezoidal shape. When the shape of the road shape is curved, the shape of each of third principal surface 21 and fourth principal surface 22 may be, for example, a parallelogram. Before the step of mounting sighting device 30 onto radio wave sensor 100, second transparent member 20 having a shape conforming to the shape of a road constituting the detection target is selected.

Workings and advantages of the installation methods of radio wave sensor 100 and sighting devices 30 according to the above-described embodiments will be described.

According to the installation method of radio wave sensor 100 as described in the above embodiment, sighting device 30 includes first transparent member 10 and second transparent member 20. The direction of radio wave sensor 100 is adjusted using first sighting mark 1 indicated on first transparent member 10 and second sighting mark 2 indicated on second transparent member 20. Thus, a worker can visually recognize a large region around the reference point through each of first transparent member 10 and second transparent member 20. Therefore, compared with when sighting device 30 is a non-transparent member, the conditions around the reference point can be quickly grasped.

According to the installation method of radio wave sensor 100 as described in the above embodiment, in the step of adjusting the direction of radio wave sensor 100 using sighting device 30 sighting device 30, the direction of radio wave sensor 100 may be adjusted such that first sighting point 81 on first sighting mark 1, second sighting point 82 on second sighting mark 2, and the reference point are aligned in a straight line. Thus, the accuracy of adjusting the direction of radio wave sensor 100 can be improved.

Further, according to the installation method of radio wave sensor 100 according to the above-described embodiment, first sighting mark 1 may be the first graph-paper pattern, and second sighting mark 2 may be the second graph-paper pattern. The first grid point of the first graph-paper pattern may be first sighting point 81, and the second grid point of the second graph-paper pattern may be second sighting point 82. Thus, the flexibility in selecting each of first sighting point 81 and second sighting point 82 increases. Therefore, an appropriate position of the reference point can be selected according to the actual road shape.

Further, according to the installation method of radio wave sensor 100 according to the above-described embodiment, in the step of adjusting the direction of radio wave sensor 100 using sighting device 30, the direction of radio wave sensor 100 may be adjusted such that the shape of first sighting mark 1 overlaps the shape of second sighting mark 2. Thus, the accuracy of adjusting the direction of radio wave sensor 100 can be improved.

Further, according to the installation method of radio wave sensor 100 as described in the above embodiment, radio wave sensor 100 may be provided with first positioning mark 60. First transparent member 10 may be provided with second positioning mark 70. In the step of mounting sighting device 30 onto radio wave sensor 100, first positioning mark 60 may be aligned with second positioning mark 70. Thus, the accuracy of positioning sighting device 30 relative to radio wave sensor 100 can be improved. As a result, the accuracy of adjusting the direction of radio wave sensor 100 can be improved.

Further, according to the installation method of radio wave sensor 100 as described in the above embodiment, radio wave sensor 100 may be provided with recess 63. In the step of mounting sighting device 30 onto radio wave sensor 100, first transparent member 10 may be fitted into recess 63. Thus, the accuracy of positioning sighting device 30 relative to radio wave sensor 100 can be improved. As a result, the accuracy of adjusting the direction of radio wave sensor 100 can be improved.

Further, according to the installation method of radio wave sensor 100 according to the above-described embodiment, radio wave sensor 100 may be provided with projecting part 80. First transparent member 10 may be provided with hole 90. In the step of mounting sighting device 30 onto radio wave sensor 100, projecting part 80 may be inserted into hole 90. Thus, the accuracy of positioning sighting device 30 relative to radio wave sensor 100 can be improved. As a result, the accuracy of adjusting the direction of radio wave sensor 100 can be improved.

Sighting device 30 according to the above-described embodiment includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped.

Sighting device 30 according to the above-described embodiment includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped. First sighting mark 1 is the first graph-paper pattern, and second sighting mark 2 is the second graph-paper pattern. Thus, the flexibility in selecting each of first sighting point 81 of first sighting mark 1 and second sighting point 82 of second sighting mark 2 increases. Therefore, an appropriate position of the reference point can be selected according to the actual road shape.

Sighting device 30 according to the above-described embodiment includes first transparent member 10 and second transparent member 20. First transparent member 10 is provided with first sighting mark 1. Second transparent member 20 is provided with second sighting mark 2. Thus, when adjusting the direction of radio wave sensor 100 using sighting device 30, a worker can visually recognize a large region around the reference point through each of first transparent member 10 and second transparent member 20. Therefore, compared with when sighting device 30 is a non-transparent member, the conditions around the reference point can be quickly grasped. First sighting mark 1 is the first concentric-circle pattern, and second sighting mark 2 is the second concentric-circle pattern. The concentric-circle patterns reflect the radiation characteristics of radio waves. Therefore, the worker can easily imagine the radiation characteristics of radio waves. For example, the worker can adjust the direction of radio wave sensor 100 while checking whether the detection target region is located within the radiation range of radio waves.

The embodiments disclosed this time should be construed as being in every respect illustrative and not restrictive. The scope of the present invention is indicated not by the above-described embodiments but by the claims, and is intended to include all changes equivalent in meaning and scope to the claims.

### REFERENCE SIGNS LIST

1 First sighting mark, 2 Second sighting mark, 3 Radio wave transmission-reception substrate, 4 Point of view, 5 First projection, 6 Second projection, 7 Road, 8 Road shoulder, 9 Median strip, 10 First transparent member, 11 First principal surface, 12 Second principal surface, 13 First side surface, 14 First bent part, 20 Second transparent member, 21 Third principal surface, 22 Fourth principal surface, 23 Second side surface, 24 Second bent part, 30 Sighting device, 31 First fixing member, 32 Second fixing member, 40 Support member, 41 First support part, 42 Second support part, 43 Third fixing member, 51 First circle, 52 Second circle, 53 Third circle, 54 Fourth circle, 55 First center part, 56 Second center part, 60 First positioning mark, 61 First mark part, 62 Second mark part, 63 Recess, 70 Second positioning mark, 71 Third mark part, 72 Fourth mark part, 80 Projecting part, 81 First sighting point, 82 Second sighting point, 90 Hole, 91 First hole part, 92 Second hole part, 100 Radio wave sensor, 101 Front surface, 102 Back surface, 103 Upper surface, 104 Lower surface, 105 Right-side surface, 106 Left-side surface, 107 Protruding part, 110 Casing, D1 First direction, D2 Second direction, L1 First distance, L2 Second distance, P1 First point, P2 Second point, P3 Mounting position, R1 First radius, R2 Second radius, R3 Third radius, R4 Fourth radius, W1 First length, W2 Second length, W3 Third length, W4 Fourth length, 10 W5 Fifth length, W6 Sixth length, W7 Seventh length, W8 Eighth length, W9 Ninth length, W10 Tenth length, W11 Eleventh length, W12 Twelfth length

1. A radio wave sensor installation method comprising:
mounting a sighting device onto a radio wave sensor;
adjusting a direction of the radio wave sensor using the sighting device;
fixing the direction of the radio wave sensor; and
removing the sighting device from the radio wave sensor, wherein
the sighting device includes a first transparent member and a second transparent member different from the first transparent member, and
in the adjusting the direction of the radio wave sensor using the sighting device, the direction of the radio wave sensor is adjusted using a first sighting mark indicated on the first transparent member and a second sighting mark indicated on the second transparent member.

2. The radio wave sensor installation method according to claim 1, wherein, in the adjusting the direction of the radio wave sensor using the sighting device, the direction of the radio wave sensor is adjusted such that a first sighting point on the first sighting mark, a second sighting point on the second sighting mark, and a reference point located on the ground are aligned in a straight line.

3. The radio wave sensor installation method according to claim 2, wherein:
the first sighting mark is a first graph-paper pattern and the second sighting mark is a second graph-paper pattern; and
a first grid point of the first graph-paper pattern is the first sighting point, and a second grid point of the second graph-paper pattern is the second sighting point.

4. The radio wave sensor installation method according to claim 3, further comprising, before the adjusting the direction of the radio wave sensor using the sighting device, drawing a mark at each of the first grid point and the second grid point.

5. The radio wave sensor installation method according to claim 1, wherein, in the adjusting the direction of the radio wave sensor using the sighting device, the direction of the radio wave sensor is adjusted such that a shape of the first sighting mark overlaps a shape of the second sighting mark as seen from a position located on an opposite side of the first transparent member from the second transparent member in a state where the first transparent member and the second transparent member are disposed facing each other.

6. The radio wave sensor installation method according to claim 1, further comprising, before the mounting the sighting device onto the radio wave sensor, selecting the first transparent member having a shape conforming to a shape of a road constituting a detection target.

7. The radio wave sensor installation method according to claim 1, wherein, in the adjusting the direction of the radio wave sensor using the sighting device, the first sighting mark is projected onto the first transparent member.

8. The radio wave sensor installation method according to claim 1, further comprising, before the adjusting the direction of the radio wave sensor using the sighting device, drawing the first sighting mark on the first transparent member.

9. The radio wave sensor installation method according to claim 1, wherein a straight line connecting the first sighting mark and the second sighting mark and a straight line along the direction of the radio wave sensor are skew.

10. The radio wave sensor installation method according to claim 1, wherein:
the radio wave sensor is provided with a first positioning mark;
the first transparent member is provided with a second positioning mark; and
in the mounting the sighting device onto the radio wave sensor, the first positioning mark is aligned with the second positioning mark.

11. The radio wave sensor installation method according to claim 1, wherein:
the radio wave sensor is provided with a recess; and
in the mounting the sighting device onto the radio wave sensor, the first transparent member is fitted into the recess.

12. The radio wave sensor installation method according to claim 1, wherein:
the radio wave sensor is provided with a projecting part;
the first transparent member is provided with a hole; and
in the mounting the sighting device onto the radio wave sensor, the projecting part is inserted into the hole.

13. A sighting device comprising:
a first transparent member; and
a second transparent member different from the first transparent member, wherein
the first transparent member is provided with a first sighting mark,
the second transparent member is provided with a second sighting mark, and
the second sighting mark has a shape that encompasses the first sighting mark when seen in a direction from the first transparent member toward the second transparent member in a state where the first transparent member and the second transparent member are overlapped.

14. A sighting device comprising:
a first transparent member; and
a second transparent member different from the first transparent member, wherein
the first transparent member is provided with a first sighting mark,
the second transparent member is provided with a second sighting mark, and
the first sighting mark is a first graph-paper pattern and the second sighting mark is a second graph-paper pattern.

15. A sighting device comprising:
a first transparent member; and
a second transparent member different from the first transparent member, wherein
the first transparent member is provided with a first sighting mark,
the second transparent member is provided with a second sighting mark, and
the first sighting mark is a first concentric-circle pattern and the second sighting mark is a second concentric-circle pattern.
